(19) United States
(12) Patent Application Publication
(10) Pub. No.: US 2024/0306669 A1
(43) Pub. Date: Sep. 19, 2024

(54) RAW-FIBER CRUSTED PELLETS, FEEDSTUFF CONTAINING THEM, AND CORRESPONDING METHODS AND USES

(71) Applicant: Farmerscent GmbH, Osnabrück (DE)

(72) Inventors: Victor Grosse Macke, Osnabrück (DE); Alexander Grunwald, Osnabrück (DE); Jan Ritter, Osnabrück (DE)

(73) Assignee: Farmerscent GmbH, Osnabrück (DE)

(21) Appl. No.: 18/675,834

(22) Filed: May 28, 2024

Related U.S. Application Data
(63) Continuation of application No. PCT/EP2022/083484, filed on Nov. 28, 2022.

(30) Foreign Application Priority Data
Nov. 30, 2021 (DE) 102021131457.7

(51) Int. Cl. A23K 10/30; A23K 40/20; A23K 40/30

(52) U.S. Cl. CPC A23K 10/30; A23K 40/20; A23K 40/30

(57) ABSTRACT

Described is a raw-fiber crusted pellet comprising one or more feedstuff additives, animal feedstuff comprising a plurality of said raw-fiber crusted pellets, and a method for producing same. Further described is the use of pellets that comprise or consist of vegetable raw fiber sources as substrate pellets for the production of raw-fiber crusted pellets, and the use of feedstuff additives for coating substrate pellets comprising vegetable raw fiber sources.

This application is a continuation of International Application No. PCT/EP2022/083484, filed Nov. 28, 2022, which claims priority to German Patent Application No. 102021131457.7, filed Nov. 30, 2021. The contents of these applications are incorporated herein by reference in their entirety.

The present invention relates to a crude-fiber crusted pellet comprising one or more feed additives, to an animal feed comprising a plurality of said crude-fiber crusted pellets and to a method for producing same. The present invention further relates to the use of pellets comprising or consisting of plant sources of crude fiber as carrier pellets for the production of crude-fiber crusted pellets and to the use of feed additives for coating carrier pellets comprising plant sources of crude fiber.

A multitude of feed additives, in particular for pets and/or livestock, are already known and have also received market authorization for this purpose. An overview of such feed additives is provided by, for example, the list of feed additives authorized in accordance with Regulation (EC) No 1831/2003 that is maintained on the web pages of the German Federal Office of Consumer Protection and Food Safety. Such authorized feed additives are nowadays generally mixed into the standard feed of animals, usually livestock, and administered in this way. However, this customary form of administration of feed additives has been found to be disadvantageous in some respects:

Frequently, only small quantities of feed additives—in the region of a few grams—need to be fed per animal per day, and so the exact metering thereof is usually only feasible or possible by means of complex technology. Specific administration of feed additives to only one particular animal or to a particular animal group is also often hardly feasible as a result. Moreover, some feed additives are difficult to handle in daily use. For instance, feed additives which are used as finely dispersed or pulverulent solids can cause dust emissions during the metering operation. Such dust emissions are often problematic because they can enter breathing air and in this way harm the health of humans and animals, especially if exposure is frequent. In the case of, for example, biochar used as a dry feed additive, a further problem is that carbon dust can settle in the surrounding spaces and permanently contaminate them. A further disadvantage of numerous feed additives, which are administered separately (unspecifically) in the way that is most common today, is the taste thereof, which is frequently clearly not found to be very pleasant by the animals being fed. In many cases, a result of this is that feed additives which are useful or necessary for animals to thrive are not ingested by the animals or are only ingested in an insufficient quantity. This means that it is nowadays often necessary to additionally administer drugs such as antibiotics to counteract the developmental disorders—such as diseases, weight faltering and/or malnutrition—caused by ingestion of insufficient quantities of feed additives necessary for animals to thrive.

Some proposals for variation of feeds or feed additives for pets or livestock are already known from the prior art.

Document GB 1 498 285 A relates to a feed additive. Document BE 1026366 A1 describes a method for producing food pieces having improved taste.

Document EP 0 080 835 A1 describes a composite material, especially suitable for oral administration to ruminants in the form of beads.

Document US 2016/0058033 A1 deals with a method for producing animal feed having a coating.

Document WO 96/22086 A1 specifies a drug-containing animal feed.

Document WO 03/029452 A2 deals with a method for producing oily suspensions of water-soluble enzymes.

The present invention therefore has for its primary object to provide a form of administration for feed additives that should be universally usable and very easy to handle in practical use, in particular meterable in a simple and specific manner without dust as far as possible. The present invention further has for its object to provide a form of administration for feed additives that is ingested readily and as completely as possible by the animals to be fed, in particular mammals as livestock and/or pets, with very good bioavailability in order to thus counteract, inter alia, developmental disorders of said animals. Additional objects of the present invention are to provide a production method for an advantageous form of administration for feed additives as described above and to specify new uses for crude-fiber pellets and feed additives.

It has now been found that, surprisingly, the primary object and further objects and/or partial objects of the present invention are achieved by a crude-fiber crusted pellet for use as animal feed, comprising or consisting of:
K1) a carrier pellet which comprises or consists of one or more plant sources of crude fiber that are preferably swellable in contact with aqueous liquid and
K2) (additionally) a crust which partially or completely covers the surface of the carrier pellet and which comprises or consists of
   K2a) one or more physiologically acceptable binders which fix the crust partially or completely covering the carrier pellet on the surface of the carrier pellet and
   K2b) one or more feed additives, wherein preferably at least some of the entirety of the one or more feed additives are fixed on the surface of the carrier pellet by the one or more physiologically acceptable binder K2a).

In our own studies, it has been found that the above-specified crude-fiber crusted pellet according to the invention, in particular in the preferred embodiments described above or below, is a form of administration for feed additives that is universally usable and very easy to handle in practical use, in particular meterable in a simple and specific manner and without dust in particular and with, at most, low losses of feed additives.

Moreover, it has been found that such a crude-fiber crusted pellet is ingested very readily and, in most cases, completely by the animals fed therewith, with excellent bioavailability at the same time, and so such a crude-fiber crusted pellet is outstandingly suitable for successful administration of feed additives as well, which would otherwise only be accepted hesitantly and/or incompletely by the animals—presumably because of a taste found to be unpleasant. This particularly good ingestion of feed additives administered by means of the crude-fiber crusted pellet according to the invention therefore leads in many cases to improved health of the animals fed therewith, and so the use of drugs such as antibiotics can then often be reduced or completely dispensed with.

The invention and combinations of preferred parameters, properties and/or constituents of the present invention that are preferred in accordance with the invention are defined in the appended claims. Preferred aspects of the present invention are also specified or defined in the description that follows and in the examples.

In general, in the context of the present invention, the carrier pellet of the constituent K1) of a crude-fiber crusted pellet according to the invention can contain or consist of, as plant source of crude fiber, any kind of customary fodder plants and/or any kind of parts of customary fodder plants and/or any kind of processed products of customary fodder plants. For preferred plant sources of crude fiber, see below.

In the context of the present invention, “crude fiber” refers—in accordance with customary nomenclature in feed technology—to the organic component of a plant material, in particular a “source of crude fiber” described in greater detail in the present text, as remains after a hydrolytic digestion process with dilute acid and dilute alkaline solution under defined conditions. Preferably, a source of crude fiber in the context of the present invention is swellable in contact with aqueous liquid, in particular with gastric acid of the fed animals (see below for the associated advantages).

The crude fiber mainly consists of cellulose and lignin. For the method of determining the proportion of crude fiber in the crude-fiber crusted pellets according to the invention, see below as well.

Preferably, in the context of the present invention and as is customary in the technical field, a “pellet” is understood to mean a small body of compressed material in regular or irregular spherical or cylindrical form. The exact shape of a pellet generally depends on the method for producing said pellet. Pellets are usually used in a plurality rather than individually, often in the form of bulk material, for an intended purpose.

Preference is given to an above-described crude-fiber crusted pellet according to the invention (or a crude-fiber crusted pellet according to the invention that is described as preferred in this text), wherein the carrier pellet K1)
comprises the one or more plant sources of crude fiber in a total amount of ≥85% by mass, preferably ≥90% by mass and particularly preferably ≥95% by mass, based on the total mass of the carrier pellet,
and preferably comprises the one or more plant sources of crude fiber in a total amount in the range from ≥85% by mass to ≤100% by mass, particularly preferably from ≥ 90% by mass to ≤100% by mass and more preferably from ≥95% by mass to ≤100% by mass, based on the total mass of the carrier pellet, or
consists of one or more plant sources of crude fiber.

The carrier pellet of the constituent K1) of the crude-fiber crusted pellet according to the invention can be produced by various different methods, each of which is known per se and each of which comprises shaping and pressing of the material used for production of the crude-fiber crusted pellet. For example, a crude-fiber crusted pellet according to the invention (or a plurality thereof) can be produced by an extrusion method known per se.

However, preference is given to the production of the carrier pellet of the constituent K1) of the crude-fiber crusted pellet according to the invention (or a plurality thereof) by die pressing, preferably flat die pressing, which is known per se. Flat dies or flat die presses particularly suitable for the pressing of the carrier pellets K1) used according to the invention are known per se, such as the LP22 flat die pellet press from Ecokraft AG, Germany, or the flat die pellet press model 39-1000 from Amandus Kahl GmbH & Co. KG, Germany.

Unlike an extruder, a die press comprises a plurality of individual pressing channels, the diameter of which specifies the diameter of the pellets produced therein: In a die press comprising pressing channels of 4 mm in diameter, what are formed are, for example, pellets of likewise 4 mm in diameter. The starting material used for production of the pellets is pressed through the pressing channels during die pressing by means of a so-called roller. On the outside of the die press (after the pressing channels), the resultant pressed strands are then removed in the desired length, preferably by cutting them off using a suitable blade. The pressing pressure gives rise to the process temperature, which is usually in the range from ≥50° C. to ≤90° C. In contrast to the extrusion method, the die pressing method generally does not involve the supply of thermal energy.

In the context of the present invention, the starting material preferably used for production of carrier pellets K1) is one or more sources of crude fiber, for example alfalfa or chopped straw, which can be shredded and/or dried in a suitable manner prior to processing in a die press. The advantage of the die pressing method compared to the extrusion method is, inter alia, that the die pressing method can also be used to process relatively coarse plant components (e.g., chopped straw) into carrier pellets, while substantially preserving in the carrier pellet the structure of the crude fibers stemming from the relatively coarse plant components.

Carrier pellets having a very high content of plant sources of crude fiber of ≥ 85% by mass, preferably of ≥90% by mass, particularly preferably of ≥95% by mass or even of 100% by mass, based on the total mass of the carrier pellet (especially an aforementioned very high content of plant sources of crude fiber that comprise crude fiber components in natural, untreated form—and thus comprise fibrous plant material, preferably long-fiber plant material), that is preferred according to the invention cannot be produced at all by extrusion methods or only with difficulty. Thus, the extrusion method, in which starting materials in powder or meal form are generally used, entails the loss of especially the structural effect of the plant sources of crude fiber and thus also the important feeding effect thereof:

Owing to the maintenance of the structure of the crude fiber, such a crude-fiber crusted pellet can make a positive contribution in animal feeding. The intestinal health of the animals fed therewith is promoted (improved intestinal peristalsis, influence on the intestinal flora, formation of short-chain fatty acids, for example butyric acid) and the swelling capacity of the crude fibers makes the digestive tract of the fed animals more voluminous, which is especially beneficial in feeding during pregnancy, since this can positively influence the feed ingestion capacity of, for example, lactating sows. For instance, the feeling of satiety occurs earlier in the animals fed in this way, and the animals become calmer. By supplying the animals with sources of crude fiber of largely intact structure (see above), it is also possible to control the rate of passage of the feed and the consistency of the feces of the animals. Moreover, nitrogen fixation in the large intestine by the bacterially fermentable material of the source of crude fiber also reduces ammonia emission, since less urea is excreted. In addition, the occurrence of tail biting among the animals can be lowered by feed rations rich in (crude) fiber.

Preference is therefore given to especially an above-described crude-fiber crusted pellet according to the invention (or a crude-fiber crusted pellet according to the invention that is described as preferred in this text), wherein the carrier pellet K1) is a die-pressed carrier pellet.

As described above, a die-pressed pellet such as the carrier pellet K1) used according to the invention is preferably produced under a lower pressure and at lower temperatures than an extruded pellet. Therefore, a die-pressed pellet has lower dimensional stability than an extruded pellet and is more sensitive to mechanical stress. In addition, an extruded pellet has a substantially more uniform (homogeneous) appearance than a die-pressed pellet, since it is usually produced from pulverulent starting materials. As indicated above, extruded pellets also cannot consist of a very high proportion of crude fiber or even entirely consist of crude fiber. Thus, in contrast to the die-pressed pellet, an extruded pellet also does not comprise any fibrous plant components, in particular long-fiber plant components.

The animals for which the crude-fiber crusted pellets according to the invention are suitable for feeding preferably include livestock, in particular mammals such as cattle, sheep, pigs, goats, camels and lamas, but also birds such as in particular chickens, turkeys, ducks or geese. Further animals for which the crude-fiber crusted pellets according to the invention are suitable for feeding include pets such as horses, dogs and cats.

Preference is also given in many cases to an above-described crude-fiber crusted pellet according to the invention (or a crude-fiber crusted pellet according to the invention that is described as preferred in this text), wherein the carrier pellet K1) comprises or consists of one or more plant sources of crude fiber and one or more physiologically acceptable binders. The one or more physiologically acceptable binders suitable for use in a carrier pellet K1) are the one or more physiologically acceptable binders K2a) (as described or defined in greater detail above or below) specified above as suitable for use in the crust K2). The one or more physiologically acceptable binders are in these cases suitable for improving or allowing the adherence of the one or more sources of crude fiber of the carrier pellet K1) to each other or to any other constituents present and can in many cases contribute to improved dimensional stability of the carrier pellet, but without achieving the dimensional stability of extruded pellets. Preferably and if applicable, the proportion by mass of the one or more physiologically acceptable binders in the carrier pellet K1) is <15% by mass, preferably <10% by mass and particularly preferably <5% by mass, based on the total mass of the carrier pellet K1).

Preferably, the constituents K1), K2a) and K2b) of the crude-fiber crusted pellet according to the invention are different from each other, i.e., in particular, a plant source of crude fiber of the constituent K1) present in a crude-fiber crusted pellet according to the invention is different from a feed additive of the constituent K2b) present in the same crude-fiber crusted pellet and different from a binder of the constituent K2a) present in the same crude-fiber crusted pellet. The same applies respectively to the constituents K2a) and K2b).

Preference is given to an above-described crude-fiber crusted pellet according to the invention (or a crude-fiber crusted pellet according to the invention that is described as preferred in this text), wherein the crust K2) comprises:
BM) a layer (BM) which is arranged on the surface of the carrier pellet and which comprises or consists of one or more physiologically acceptable binders K2a) and
FA) a (further) layer (FA) which is arranged on the layer BM and which comprises or consists of one or more feed additives K2b),
such that the carrier pellet K1) is partially or completely covered by a first bilayer BM)/FA) which forms the crust K2) and preferably comprises the layers BM) and FA). In a preferred variant of this embodiment, the crust K2) consists of the aforementioned first bilayer BM)/FA).

In the context of the present text, the expression “layer BM)” refers to a layer which comprises or preferably consists of one or more physiologically acceptable binders (as defined in greater detail above or below, “K2a)”). Preferably, a layer BM) is arranged on the surface of the carrier pellet or on a layer FA).

In the context of the present text, the expression “layer FA)” refers to a layer which comprises or preferably consists of one or more feed additives (as defined in greater detail above or below, “K2b)”). Preferably, a layer FA) is arranged on a layer BM).

In the context of the present text, the expression “bilayer BM)/FA)” refers to a layer (or bilayer) which comprises a layer BM) (as defined above) and, arranged thereon, a layer FA) (as defined above). Preferably, the layer BM) of a bilayer BM)/FA) is in each case arranged nearer to the carrier pellet than the layer FA) of said bilayer BM)/FA).

Usually, the average thickness of a layer BM) or the average thickness of a layer FA) of a crude-fiber crusted pellet according to the invention is ≤5 mm, preferably ≤3 mm and particularly preferably ≤1.5 mm and is in many cases in the range from 0.5 mm to 5 mm, preferably from 0.7 mm to 3 mm.

Furthermore, preference is also given to an above-described crude-fiber crusted pellet according to the invention (or a crude-fiber crusted pellet according to the invention that is described as preferred in this text), wherein one, two or more than two further bilayers BM)/FA) are arranged on the layer FA) of the first bilayer BM)/FA), such that the carrier pellet K1) is partially or completely covered by a plurality of alternating bilayers BM)/FA) that forms the crust K2),
wherein preferably there is alternation in the crust K2) between a layer BM) comprising one or more physiological binders K2a) and a layer FA) comprising one or more feed additives K2b), such that each layer BM) fixes a layer FA) arranged on said layer BM) on the next layer arranged under said layer BM) (or on the surface of the carrier pellet in the lowest layer). The individual layers BM) of the crust K2) and/or the individual layers FA) of the crust K2) can each be identical or different in this preferred embodiment of the crude-fiber crusted pellet according to the invention. It is preferred in this embodiment if at least one layer FA) (preferably all layers FA) present) comprise or consist of only one feed additive K2b) (not multiple feed additives K2b)), for example at least one layer FA) of a crude-fiber crusted pellet according to the invention contains only or consists (only) of biochar as feed additive.

A particular advantage of the variant of the crude-fiber crusted pellet according to the invention described herein above is that the amount (or concentration) of one or more feed additives per crude-fiber crusted pellet can be controlled by the number of layers FA) applied to the carrier pellet, i.e., increased or decreased as desired and depending on the needs of the particular animals to be fed.

In a further variant of the present invention, preference is also given to an above-described crude-fiber crusted pellet according to the invention (or a crude-fiber crusted pellet according to the invention that is described as preferred in this text), wherein the crust K2) comprises at least one layer which is arranged on the carrier pellet K1), preferably on the surface of the carrier pellet K1), and which comprises or consists of a mixture of i) one or more physiologically acceptable binders K2a) and ii) one or more feed additives K2b).

Preference is then also given to an above-described crude-fiber crusted pellet according to the invention (or a crude-fiber crusted pellet according to the invention that is described as preferred in this text), wherein the one or more plant sources of crude fiber of the carrier pellet K1)
comprise or consist of plant cell-wall material,
wherein preferably the plant cell-wall material comprises or is a plant cell-wall material which stems from whole plants, plant parts and/or processed plant products of one or more plant species (preferably fodder plant species) in each case; and/or
comprise or (preferably) consist of plant material selected from the group consisting of wheat bran, beet pulp, fruit pomace (preferably apple pomace), alfalfa (preferably alfalfa meal), soybean hulls, cereal straw, hay, grass, grass silage, corn silage, lignocellulose and mixtures thereof,
preferably from the group consisting of beet pulp, fruit pomace, alfalfa, soybean hulls, cereal straw, hay, grass, grass silage, corn silage, lignocellulose and mixtures thereof, particularly preferably from the group consisting of alfalfa, cereal straw, hay, grass, grass silage, corn silage, lignocellulose and mixtures thereof, wherein especially preferably the plant material comprises or is alfalfa, particularly preferably alfalfa meal; and/or
comprise or consist of cellulose-containing plant material; and/or
comprise fibrous plant material, preferably long-fiber plant material.

In the context of the present invention, a plant material as source of crude fiber can be that of just one source of crude fiber (for instance, that of wheat bran), or it can be a plant material of a combination or mixture of two or more plant materials (for instance, a combination or mixture of wheat bran, alfalfa meal and beet pulp). Alfalfa, in particular alfalfa meal, is a source of crude fiber for a carrier pellet K1) that is particularly preferred for the purposes of the present invention because alfalfa has a comparatively high protein content and is inter alia therefore particularly valuable for supplying nutrients to the animals to be fed with crude-fiber crusted pellets according to the invention.

Preference is then also given to an above-described crude-fiber crusted pellet according to the invention (or a crude-fiber crusted pellet according to the invention that is described as preferred in this text), wherein the one feed additive K2b) or at least one, several or all of the multiple feed additives K2b) (preferably all the feed additives K2b)):
are feed additives as specified in Article 2(2)(a) in conjunction with Article 5(3)(a), (b), (e) and/or (g) of Regulation (EC) No 1831/2003, preference being given to exclusion of antibiotics; and/or
are selected from the group consisting of
biochar;
algae products, preferably selected from the group consisting of brown algae, red algae, green algae, blue algae, diatoms and mixtures thereof;
mineral powders, preferably selected from the group consisting of bentonite, zeolite, humic acids and mixtures thereof;
organic acids preferably selected from the group consisting of formic acid; benzoic acid; citric acid; proteinogenic amino acids, preference being given to selecting the proteinogenic amino acids from the group consisting of cystine, arginine, isoleucine, tyrosine, leucine, tryptophan, lysine, methionine, phenylalanine, valine and mixtures thereof; and mixtures thereof;
coccidiostats, preferably selected from the group consisting of lasalocid sodium, narasin, salinomycin sodium, monensin sodium, semduramicin sodium, maduramicin ammonium, robenidine hydrochloride, decoquinate, halofuginone hydrobromide, nicarbazin and diclazuril;
essential oils, preferably selected from the group of oils of wormwood, mugwort, gentian, yarrow, anise, caraway, fennel, juniper, parsley, elderberry, linden, eucalyptus, thyme, spruce, valerian, hop, melissa, chamomile, nasturtium, oregano, cassia, lemongrass, peppermint, tea tree, amber, coriander, sage and mixtures thereof;
enzymes, preferably selected from the group consisting of phytases, carbohydrases, proteases, lipases, lysozyme, laccases, hexose oxidases and mixtures thereof;
minerals present in ionic form, preferably selected from the group consisting of chlorine, potassium, calcium, magnesium, sodium, phosphorus, sulfur; chromium, iron, fluorine, iodine, cobalt, copper, manganese, molybdenum, selenium, silicon, vanadium, zinc and mixtures thereof;
vitamins, preferably selected from the group consisting of vitamin A, vitamin E, vitamin D, vitamin K, vitamin B1, vitamin B6, vitamin C, vitamin B12, niacin, pantothenic acid, folic acid, biotin and mixtures thereof;
rare earths, preferably selected from the group consisting of scandium, yttrium, lanthanides, lanthanum, cerium, praseodymium, neodymium, promethium, samarium, europium, gadolinium, terbium, dysprosium, holmium, erbium, thulium, ytterbium, lutetium and mixtures thereof;
probiotics, preferably selected from the group consisting of Lactobacilli; Bifidobacteria, Streptococci, Enterococci, Aspergillus fungal species, Candida fungal species, Saccharomyces yeasts and mixtures thereof;
prebiotics and
mixtures thereof,
wherein preferably the one feed additive or at least one of the multiple feed additives is biochar; and/or

1 is/are different from the one or more plant sources of crude fiber of the carrier pellets and/or from the one or more physiologically acceptable binders of the crust K2).

Particular preference is given here to an above-described crude-fiber crusted pellet according to the invention (or a crude-fiber crusted pellet according to the invention that is described as preferred in this text), wherein the one feed additive K2b) or at least one, several or all of the multiple feed additives K2b) (preferably all the feed additives K2b)) are selected from the group consisting of
biochar;
algae products, preferably selected from the group consisting of brown algae, red algae, green algae, blue algae, diatoms and mixtures thereof;
mineral powders, preferably selected from the group consisting of bentonite, zeolite, humic acids and mixtures thereof;
essential oils, preferably selected from the group of oils of wormwood, mugwort, gentian, yarrow, anise, caraway, fennel, juniper, parsley, elderberry, linden, eucalyptus, thyme, spruce, valerian, hop, melissa, chamomile, nasturtium, oregano, cassia, lemongrass, peppermint, tea tree, amber, coriander, sage and mixtures thereof; and
mixtures thereof,
wherein preferably the one feed additive or at least one of the multiple feed additives is biochar.

The above-specified, particularly preferred group of feed additives (consisting of biochar, algae products, mineral powders and essential oils) is present in currently employed standard feeds in rare cases at most and is instead usually administered separately to animals requiring or benefiting from such feed additives. Since said feed additives are generally given only in small quantities and then usually in powder form, precise metering thereof is difficult at present and the loss rate (i.e., the portion of the feed additives given to the animals, but not ingested by the animals) is high. Said feed additives therefore particularly benefit from administration in the form of the crude-fiber crusted pellets according to the invention. In addition, the feed additives are, in each case, natural or isolated (or prepared) from naturally occurring sources.

In the context of the present invention, a crude-fiber crusted pellet according to the invention or the crust thereof can comprise just one feed additive (e.g., biochar), or said pellet (or the crust thereof) can comprise a combination or mixture of two or more feed additives (for instance, a combination or mixture of biochar, amino acid and mineral powder).

In the context of the present invention and as is customary in the technical field, the term “probiotics” or “probiotic substances” preferably refers to preparations containing viable microorganisms (as defined above), preferably lactic acid bacteria (Lactobacilli) and/or yeasts (Saccharomyces yeasts).

In the context of the present invention and as is customary in the technical field, the term “prebiotics” preferably refers to nondigestible food ingredients that promote bacterial growth and activity in the mammalian intestine, preferably dietary fibers selected from the group consisting of inulin, oligofructose and mixtures thereof.

Preference is furthermore also given to an above-described crude-fiber crusted pellet according to the invention (or a crude-fiber crusted pellet according to the invention that is described as preferred in this text), wherein the one physiologically acceptable binder K2a) or at least one, several or all of the multiple physiologically acceptable binders K2a) are selected from the group consisting of carboxymethylcelluloses, dextrins, alginates, starch (preferably cereal starch), xanthan gum, molasses and vinasse, wherein preferably the one physiologically acceptable binder K2a) or at least one of the multiple physiologically acceptable binders K2a) is wheat starch, particularly preferably liquid wheat starch.

In the context of the present invention, a crude-fiber crusted pellet according to the invention can comprise just one physiologically acceptable binder (e.g., wheat starch), or it can comprise a combination or mixture of two or more physiologically acceptable binders (e.g., wheat starch, molasses and alginates).

The present invention also relates to an animal feed comprising or consisting of a plurality of above-described crude-fiber crusted pellets according to the invention (or of crude-fiber crusted pellets according to the invention that are described as preferred in this text).

With regard to preferred embodiments of the animal feed according to the invention, as mentioned herein above, the explanations given above for the crude-fiber crusted pellet according to the invention, especially regarding possible preferred embodiments and possible or preferred combinations, apply accordingly (mutatis mutandis where appropriate) and vice versa.

An above-specified animal feed according to the invention has a number of beneficial effects on animals fed therewith, and said effects are even mutually enhanceable:

For instance, the crude fiber content of an animal feed according to the invention (or its content of one or more plant sources of crude fiber) causes mechanical satiety in the animals. Owing to the swelling of the crude fiber or the sources of crude fiber, the stomach of a fed animal is filled more rapidly, and so the animal becomes calmer. Various tests demonstrate the positive effect of sources of crude fiber on aggressive behavior in animals. In addition, swelling of sources of crude fiber that are swellable in contact with aqueous liquid (in particular with the gastric acid of the animals fed therewith) causes improved (more rapid and more complete) release of the feed additives arranged in the crust, and so the feed additives administered by the crude-fiber crusted pellet according to the invention are bioavailable in a particularly efficient manner.

Also, the swelling of the animal feed according to the invention, or of the plant sources of crude fiber present therein, improves passage through the intestine. The increased pressure on the intestinal walls reduces the risk of constipations and the feed passes through the gastrointestinal tract of an animal more rapidly than would occur without the feed according to the invention.

A further positive effect is based on the fact that crude fiber generally cannot be digested by endogenous enzymes. They are therefore usually digested only in the large intestine (preferably of a mammal) by the microflora resident there. This usually produces short-chain fatty acids, which support the supply of energy to the animals thus fed and promote the health of the intestinal wall.

In the animal feed according to the invention, the one or more feed additives are fixed (bound) to the carrier pellet by binders, and so the release of the feed additives begins only after the feed has been ingested. This reduces possible loss of feed additive.

The handling of feed additives is distinctly simplified by the application to free-flowing material (in this case: the carrier pellet K1)) and they can therefore be handled precisely and without using precision balances.

As already mentioned, the acceptance of feed additives can also be distinctly improved in the animals fed with the animal feed according to the invention—presumably because the animals perceive the taste of crude-fiber crusted pellets according to the invention to be more pleasant compared to the pure feed additives—and so the feed additives are thus more readily ingested by the animals. Consequently, use of natural feed additives that is possible with greater efficiency in this way means that the use of antibiotics in livestock farming can be reduced in many cases and distinctly reduced in some cases, while usually increasing economic output at the same time.

In addition, the mechanical properties of the animal feed according to the invention, or of the crude-fiber crusted pellets according to the invention present therein, are distinctly nearer to the natural feeding behavior of animals than purely ingesting feed additives in the form of powders, for instance.

As already discussed above, different feed additives can be applied to the carrier pellets in different concentrations and combinations, thus allowing production of crude-fiber crusted pellets tailored in each case to the needs of particular animals or animal groups. In addition, soiling or contamination by feed additives can be prevented by application thereof to carrier pellets.

Increased health due to the administration of the animal feed according to the invention in animals fed with said feed therefore ultimately also results in improved animal welfare. Preference is given to an above-described animal feed according to the invention (or an animal feed according to the invention that is described as preferred in this text), wherein the crust K2)
contains the one or more feed additives K2b) in a total amount in the range from 2% to 35% by mass, preferably from 3.5% to 25% by mass and particularly preferably from 5% to 20% by mass, based on the total mass of the plurality of crude-fiber crusted pellets present in the animal feed; and/or
contains the one or more physiologically acceptable binders K2a) in a total amount in the range from 0.5% to 17.5% by mass, preferably from 1% to 12.5% by mass and particularly preferably from 2% to 10% by mass, based on the total mass of the plurality of crude-fiber crusted pellets present in the animal feed.

The one or more feed additives K2b) can be advantageously tailored, on the basis of type and quantity/proportion (in the context of specific metering), to the animals/animal groups and/or animal species to be fed with corresponding crude-fiber crusted pellets according to the invention, so as to optimize the desired effects of the one or more feed additives with respect to the animals/animal groups and/or animal species.

The one or more physiologically acceptable binders K2a) can be advantageously tailored, on the basis of type and quantity/proportion, to the one or more plant sources of crude fiber of the carrier pellet (and optionally to its other constituents) and to the one or more feed additives K2b), so as to optimize the desired fixation of the one or more feed additives on the surface of the carrier pellet.

Furthermore, preference is also given to an above-described animal feed according to the invention (or an animal feed according to the invention that is described as preferred in this text), wherein the one or more plant sources of crude fiber of the carrier pellets K1) of the plurality of crude-fiber crusted pellets present in the animal feed
are present in a total amount of ≥ 30% by mass, preferably in a total amount of ≥ 40% by mass, particularly preferably in a total amount of ≥ 50% by mass and more preferably in a total amount of ≥85% by mass, based on the total mass of the plurality of crude-fiber crusted pellets present in the animal feed; and/or
are present in a total amount in the range from 47.5% to 97.5% by mass, preferably in the range from 62.5% to 95.5% by mass and particularly preferably in the range from 70% to 93% by mass, based on the total mass of the plurality of crude-fiber crusted pellets present in the animal feed;
wherein preferably the total amount of the one or more plant sources of crude fiber of the carrier pellets K1) of the plurality of crude-fiber crusted pellets present in the animal feed is determined in each case according to the Weender feed analysis method.

The plant sources of crude fiber can be advantageously tailored, on the basis of type and quantity/proportion, to the animals/animal groups and/or animal species to be fed with corresponding crude-fiber crusted pellets according to the invention, so as to optimize, for example, ingestion by the animals or to optimally meet the needs of the animals, animal species and/or animal groups in this respect.

In the context of the present invention, the “Weender feed analysis method” is preferably understood in case of doubt to mean the method as described in “Methodenbuch Bd. III” [Method book vol. III], VDLUFA-Verlag Darmstadt, 3rd edition 1976 (ISBN 978-3-941273-14-6), “Die chemische Untersuchung von Futtermitteln” [Chemical testing of feeds], section 6.1.4 “Schnellverfahren zur Bestimmung der Rohfaser” [Rapid method for crude fiber determination] in the 3rd supplement 1993, where “VDLUFA” stands for “Verband Deutscher Landwirtschaftlicher Untersuchungsund Forschungsanstalten” [Association of German Agricultural Inspection and Research Institutes].

Preference is also given to an above-described animal feed according to the invention (or an animal feed according to the invention that is described as preferred in this text), wherein
at least 80% by volume of the plurality of crude-fiber crusted pellets present in the animal feed have a diameter of ≤20 mm, preferably of ≤15 mm and particularly preferably of ≤10 mm, preferably determined by sieving, and/or
at least 80% by volume of the plurality of crude-fiber crusted pellets present in the animal feed have a diameter in the range from 2 to 20 mm, preferably from 3 to 15 mm and particularly preferably from ≥4 to ≤10 mm, preferably determined by sieving, and/or
at least some of the plurality of crude-fiber crusted pellets (preferably at least 50% by volume of the plurality of crude-fiber crusted pellets present in the animal feed) are in the form of cylindrical, preferably circular cylindrical, strand fragments or strand cuts, wherein preferably the diameter of the cylindrical strand fragments or strand cuts of crude-fiber crusted pellets is in the range from 2 to 20 mm, preferably from 3 to 15 mm and particularly preferably from ≥4 to ≤10 mm.

It has been found in our own experiments that crude fiber pellets that are known per se and already successfully used in agricultural practice today and are of known and customary shapes and dimensions (as described or defined above, in particular die-pressed crude fiber pellets) are outstandingly suitable as carrier pellets for the production of the crude-fiber crusted pellets according to the invention. Such crude fiber pellets that are already known and used are easily producible in large quantities by known and established methods and readily available on the market. Furthermore, such crude fiber pellets are willingly and readily accepted and utilized by many animals, the ingestion thereof by the animals being associated with the beneficial effects already mentioned above.

The present invention then also relates to a method for producing crude-fiber crusted pellets for use as animal feed, comprising (or consisting of) the steps of:
S1) producing or providing a plurality of carrier pellets K1) which comprise or consist of plant sources of crude fiber as specified or defined above (or as specified or defined as preferred above),
S2) producing or providing one or more feed additives K2b) as specified or defined above (or as specified or defined as preferred above), preferably in a sprayable form,
S3) producing or providing one or more physiologically acceptable binders K2a) as specified or defined above (or as specified or defined as preferred above),
S4) applying the one or more binders K2a) produced or provided in step S3) and the one or more feed additives K2b) produced or provided in step S2) to the plurality of carrier pellets produced or provided in step S1);

preferably such that crude-fiber crusted pellets result, wherein preferably the surface of the plurality of carrier pellets is partially or completely covered in each case by a crust comprising or consisting of one or more physiologically acceptable binders and one or more feed additives.

With regard to preferred embodiments of the method according to the invention for producing crude-fiber crusted pellets, as mentioned herein above, the explanations given above for the crude-fiber crusted pellet according to the invention and for the feed according to the invention, especially regarding possible preferred embodiments and possible or preferred combinations, apply accordingly (mutatis mutandis where appropriate) and vice versa.

The method according to the invention for producing crude-fiber crusted pellets, as mentioned herein above, can preferably be carried out analogously to a seed coating method known per se. In a preferred variant of the method according to the invention, a plurality of carrier pellets (constituent K1) of a crude-fiber crusted pellet according to the invention) can be coated with the one or more physiologically acceptable binders (constituent K2a) of a crude-fiber crusted pellet according to the invention) and with the one or more feed additives (constituent K2b) of a crude-fiber crusted pellet according to the invention) in a one-step or multistep method.

For this purpose, the plurality of carrier pellets are set in rotation by means of a suitable rotation device, preferably a rotation chamber known per se, preferably by swirling, preferably swirling in a gas atmosphere, in particular swirling in an air atmosphere. The rotation or swirling of the plurality of carrier pellets can be produced by air pressure or else by (other) mechanical rotation. In the case of use of a rotation chamber, one or more binders and one or more feed additives are applied (preferably by spin coating or spraying) to a rotating disk, preferably arranged in the center of the rotation chamber, at the same time or preferably alternately one after another, and the amount of the binders and feed additives to be applied can be controlled as desired and according to the crude-fiber crusted pellets to be produced. The feed additives can be used in powder (pulverulent) form, gel form and/or liquid form; this means that, for example, it is also possible for a portion of the (total) feed additives (used) to be used in powder form and another portion of the (total) feed additives (used) to be used in gel form, or that, for example, it is also possible for a portion of the (total) feed additives (used) to be used in gel form and another portion of the (total) feed additives (used) to be used in liquid form.

As a result of the rotation of, for example, a rotating disk that is used, the binders and feed additives are then distributed over the plurality of carrier pellets (preferably set in rotation by swirling in an air atmosphere), thereby resulting in the crude-fiber crusted pellets according to the invention. Depending on the binders and feed additives used, it may then be necessary or convenient for the resultant crude-fiber crusted pellets to be additionally dried or left to dry before they are used further.

In a preferred variant of the method according to the invention for producing crude-fiber crusted pellets, the method is carried out by means of a seed coating system. Seed coating systems usable or suitable for this purpose are known per se, for example from document WO 2016/162281 A1. In a further preferred variant of the method according to the invention for producing crude-fiber crusted pellets, the method is carried out by means of a seed treatment system known per se, such as a wet-treatment system, for example a universal batch wet-treatment unit from Willy Niklas GmbH Apparatebau.

Preference is given to an above-described method according to the invention for producing crude-fiber crusted pellets (or a method according to the invention for producing crude-fiber crusted pellets that is described as preferred in this text), wherein in step S4):
the one or more binders K2a) and the one or more feed additives K2b) are applied simultaneously to the plurality of carrier pellets; or
the one or more binders K2a) and the one or more feed additives K2b) are applied to the plurality of carrier pellets once, twice or more than twice, preferably in alternation between each other, wherein preferably one or more feed additives K2b) are applied last.

Possible methods for application of the one or more binders and the one or more feed additives to the plurality of carrier pellets K1) include all known methods and systems for the application of materials in powder form, gel form or liquid form to a plurality of carrier particles (see also above), preferably spin coating (e.g., rotation chamber), spraying and/or immersion. If the plurality of carrier pellets K1) produced or provided in step S1) of the method according to the invention comprises die-pressed carrier pellets K1) (especially if a plurality of die-pressed carrier pellets is produced or provided in step S1)), the preferred method of application of the one or more binders and the one or more feed additives to the plurality of carrier pellets K1) is spin coating (in the case of solids in powder form, such as biochar) or spraying (in the case of binders and feed additives which are in liquid form or are dissolved or suspended in liquid).

Preference (see the above explanations for the advantages) is given to an above-described method according to the invention for producing crude-fiber crusted pellets (or a method according to the invention for producing crude-fiber crusted pellets that is described as preferred in this text), wherein the plurality of carrier pellets K1) produced or provided in step S1) comprises die-pressed carrier pellets K1) (especially preferably wherein a plurality of die-pressed carrier pellets is produced or provided in step S1)).

Owing to the comparatively low dimensional stability of die-pressed carrier pellets K1) (see above) and the greater sensitivity thereof to mechanical stress (compared to, for example, extruded carrier pellets), coating of die-pressed pellets with a crust K2) which partially or completely covers the surface of the carrier pellets is more complex than, for instance, coating extruded pellets, since die-pressed carrier pellets must be treated particularly gently during the coating operation in order to avoid breakage thereof or mechanical damage thereto.

Furthermore, therefore, preference is given to an above-described method according to the invention for producing crude-fiber crusted pellets (or a method according to the invention for producing crude-fiber crusted pellets that is described as preferred in this text), wherein
in step S4) the plurality of carrier pellets K1) is set in rotation and preferably the one or more binders K2a) and the one or more feed additives K2b) are applied, preferably by spin coating or spraying, to the carrier pellets of the plurality of carrier pellets set in rotation, once, twice or more than twice, preferably in alternation between each other; and/or
in step S4) at least some of the produced or provided plurality of carrier pellets K1) (preferably the produced or provided plurality of carrier pellets K1)) is set in rotation by swirling in a gas atmosphere, preferably swirling in an air atmosphere, and the application of the one or more binders K2a) produced or provided in step S3) and/or (preferably “and”) the one or more feed additives K2b) produced or provided in step S2) is done to the carrier pellets K1) thus set in rotation (by swirling in a gas atmosphere, preferably in an air atmosphere); and/or
in step S2) the one or more feed additives K2b) are produced or provided in powder (pulverulent) form, gel form and/or liquid form.

The present invention also relates to a plurality of crude-fiber crusted pellets for use as animal feed, produced or producible by an above-specified method according to the invention (or by a method according to the invention that is described as preferred in this text).

With regard to preferred embodiments of the plurality of crude-fiber crusted pellets according to the invention produced or producible by an above-specified method according to the invention, as mentioned herein above, the explanations given above for the crude-fiber crusted pellet according to the invention, for the animal feed according to the invention and for the method according to the invention for producing crude-fiber crusted pellets, especially regarding possible preferred embodiments and possible or preferred combinations, apply accordingly (mutatis mutandis where appropriate) and vice versa.

The present invention furthermore also relates to the use of a pellet, preferably a die-pressed pellet, comprising one or more plant sources of crude fiber in a total amount of ≥85% by mass, preferably of ≥90% by mass and particularly preferably of ≥95% by mass, based on the total mass of the pellet, or consisting of plant sources of crude fiber as a carrier pellet for the production of a crude-fiber crusted pellet,
wherein preferably the crude-fiber crusted pellet has a crust which partially or completely covers the surface of the carrier pellet and which comprises or consists of one or more physiologically acceptable binders and one or more feed additives.

With regard to preferred embodiments of the use according to the invention of pellets comprising or consisting of plant sources of crude fiber, as mentioned herein above, the explanations give above for the crude-fiber crusted pellet according to the invention, for the animal feed according to the invention, for the method according to the invention for producing crude-fiber crusted pellets and for the plurality of crude-fiber crusted pellets according to the invention produced or producible by an above-specified method according to the invention, especially regarding possible preferred embodiments and possible or preferred combinations, apply accordingly (mutatis mutandis where appropriate) and vice versa.

The present invention likewise also relates to the use of one or more feed additives for coating carrier pellets, preferably a plurality of carrier pellets, which comprise or consist of plant sources of crude fiber, preferably for coating a plurality of carrier pellets K1) as described above (or a plurality of carrier pellets K1) that is described as preferred in this text).

With regard to preferred embodiments of the use according to the invention of one or more feed additives, as mentioned herein above, the explanations given above for the crude-fiber crusted pellet according to the invention, for the animal feed according to the invention, for the method according to the invention for producing crude-fiber crusted pellets, for the plurality of crude-fiber crusted pellets according to the invention produced or producible by an above-specified method according to the invention and for the use according to the invention of pellets comprising or consisting of plant sources of crude fiber, especially regarding possible preferred embodiments and possible or preferred combinations, apply accordingly (mutatis mutandis where appropriate) and vice versa.

### EXAMPLES

The examples stated below are intended to describe and explain the invention in greater detail without limiting the scope thereof.

### Example 1: Production of Crude-Fiber Crusted Pellets According to the Invention

5 kg of commercially available, die-pressed, cylindrical alfalfa pellets (diameter of approx. 6-8 mm, length of approx. 18-20 mm, total amount of alfalfa as plant source of crude fiber in an alfalfa pellet ≥ 95% by mass, based on the total mass of the alfalfa pellet) as carrier pellets were poured into the mixing cylinder of a customary seed treatment system (universal batch wet-treatment unit model W.N. 5/15 from Willy Niklas Apparatebau, Germany). The seed treatment system set the pellets in rotary motion by means of an air flow, thus swirling them in an air atmosphere. At the same time here, adherent dust was blown off the pellets and removed by means of a suction device.

375 g of liquid wheat starch (“Crespovit® starch, liquid” from Crespeo/Crespel & Deiters GmbH & Co KG, Germany) as binder were then fed into the seed treatment chamber by means of the metering device of the seed treatment system and distributed over the surfaces of the alfalfa pellets which are rotating (and at the same swirled in an air atmosphere) with the aid of the spray disk of the wet-treatment unit.

Thereafter, 500 g of pulverulent biochar as feed additive were added to the rotating disk by means of the metering device of the seed treatment system and applied to the wheat starch-coated alfalfa pellets which are rotating (see above). In the present case, no further layers of binder or feed additive were subsequently applied, thus resulting in crude-fiber crusted pellets with a crust consisting of a layer (BM) which is arranged on the surface of the carrier pellet and which consists of wheat starch as physiologically acceptable binder K2a) and a layer (FA) which is arranged on the layer (BM) and consists of biochar as feed additive K2b), such that a resultant alfalfa carrier pellet K1) was partially or completely covered by a first bilayer BM/FA which forms the crust K2).

After completion of the seed treatment process, the seed treatment chamber was opened and the pellets were removed. If the crude-fiber crusted pellets are to be produced on a larger scale, the finished crude-fiber crusted pellets can then be, for example, transported onward via conveyor belts and packaged.

### Example 2: Production of Crude-Fiber Crusted Pellets According to the Invention (Variant)

Crude-fiber crusted pellets were produced as described above in Example 1. In a modification of the test procedure according to Example 1, the alfalfa pellets as carrier pellets were now, however, not set in rotary motion by means of an air flow, but were instead swirled mechanically in an air atmosphere by means of a rotary cup and set in rotation in this way.

### Example 3: Use of Crude-Fiber Crusted Pellets According to the Invention as Animal feed (pig)

10 kg of alfalfa crude-fiber crusted pellets produced as described above in Example 1 (from multiple production batches of the same kind) were fed into a commercially available dry feed machine (model: Porky's Pelletomat from Meyer-Brakenberg, Germany). The dry feed machine (pellet machine) loaded in this way was installed in a bay with ten piglets (each piglet weighing approx. 26 kg). The piglets were able to ingest the pellets from the pellet machine ad libitum and did so immediately. An average of 80 g of crude-fiber crusted pellet was ingested per animal per day. After the crude-fiber crusted pellets according to the invention had been administered for some time, the farmer found an improvement in the piglets fed in this way in terms of the symptoms of necrosis of the margin of the ear, presumably due to the toxin-binding effect of biochar. Moreover, an improvement in fecal consistency in the piglets was found.

In contrast to using purely biochar, no dust formation was found in the compartment. The handling of the crude-fiber crusted pellets according to the invention was distinctly simplified for the farmer compared to the handling of pulverulent biochar.

1. A crude-fiber crusted pellet for use as animal feed, comprising or consisting of:
K1) a carrier pellet which comprises one or more plant sources of crude fiber and
K2) a crust which partially or completely covers a surface of the carrier pellet and which comprises
K2a) one or more physiologically acceptable binders which fix the carrier pellet-covering crust on the surface of the carrier pellet and
K2b) one or more feed additives.

2. The crude-fiber crusted pellet as claimed in claim 1, wherein the carrier pellet K1) comprises the one or more plant sources of crude fiber in a total amount of ≥ 85% by mass based on the total mass of the carrier pellet.

3. The crude-fiber crusted pellet as claimed in claim 1, wherein the one or more plant sources of crude fiber of the carrier pellet K1) comprise plant material selected from the group consisting of wheat bran, beet pulp, fruit pomace, alfalfa, soybean hulls, cereal straw, hay, grass, grass silage, corn silage, lignocellulose and mixtures thereof.

4. The crude-fiber crusted pellet as claimed in claim 1, wherein the carrier pellet K1) is a die-pressed carrier pellet.

5. The crude-fiber crusted pellet as claimed in claim 1, wherein the crust K2) comprises:
BM) a layer which is arranged on the surface of the carrier pellet and which comprises one or more physiologically acceptable binders K2a) and
FA) a layer which is arranged on the layer BM) and which comprises one or more feed additives K2b),
such that the carrier pellet K1) is partially or completely covered by a first bilayer BM)/FA) which forms the crust K2).

6. The crude-fiber crusted pellet as claimed in claim 1, wherein
the one or more plant sources of crude fiber of the carrier pellet K1) comprise plant cell-wall material.

7. The crude-fiber crusted pellet as claimed in claim 1, wherein the one or more feed additives K2b)
are feed additives as specified in Article 2(2)(a) in conjunction with Article 5(3)(a), (b), (e) and/or (g) of Regulation (EC) No 1831/2003, preference being given to exclusion of antibiotics; and/or
are selected from the group consisting of:
biochar;
algae products selected from the group consisting of brown algae, red algae, green algae, blue algae, diatoms and mixtures thereof;
mineral powders selected from the group consisting of bentonite, zeolite, humic acids and mixtures thereof;
organic acids selected from the group consisting of formic acid; benzoic acid; citric acid; proteinogenic amino acids, preference being given to selecting the proteinogenic amino acids from the group consisting of cystine, arginine, isoleucine, tyrosine, leucine, tryptophan, lysine, methionine, phenylalanine, valine and mixtures thereof; and mixtures thereof;
coccidiostats selected from the group consisting of lasalocid sodium, narasin, salinomycin sodium, monensin sodium, semduramicin sodium, maduramicin ammonium, robenidine hydrochloride, decoquinate, halofuginone hydrobromide, nicarbazin and diclazuril;
essential oils selected from the group of oils of worm-wood, mugwort, gentian, yarrow, anise, caraway, fennel, juniper, parsley, elderberry, linden, eucalyptus, thyme, spruce, valerian, hop, melissa, chamomile, nasturtium, oregano, cassia, lemongrass, peppermint, tea tree, amber, coriander, sage and mixtures thereof;
enzymes selected from the group consisting of phytases, carbohydrases, proteases, lipases, lysozyme, laccases, hexose oxidases and mixtures thereof;
minerals present in ionic form selected from the group consisting of chlorine, potassium, calcium, magnesium, sodium, phosphorus, sulfur; chromium, iron, fluorine, iodine, cobalt, copper, manganese, molybdenum, selenium, silicon, vanadium, zinc and mixtures thereof;
vitamins selected from the group consisting of vitamin A, vitamin E, vitamin D, vitamin K, vitamin B1, vitamin B6, vitamin C, vitamin B12, niacin, pantothenic acid, folic acid, biotin and mixtures thereof;
rare earths selected from the group consisting of scandium, yttrium, lanthanides, lanthanum, cerium, praseodymium, neodymium, promethium, samarium, europium, gadolinium, terbium, dysprosium, holmium, erbium, thulium, ytterbium, lutetium and mixtures thereof;
probiotics selected from the group consisting of Lactobacilli; Bifidobacteria, Streptococci, Enterococci, Aspergillus fungal species, Candida fungal species, Saccharomyces yeasts and mixtures thereof;
prebiotics and
mixtures thereof.

8. An animal feed comprising a plurality of crude-fiber crusted pellets as claimed in claim 1.

9. The animal feed as claimed in claim 8, wherein
the crust K2) contains the one or more feed additives K2b) in a total amount in a range from 2% to 35% by mass, based on the total mass of the plurality of crude-fiber crusted pellets present in the feed; and/or
the crust K2) contains the one or more physiologically acceptable binders K2a) in a total amount in the range from 0.5% to 17.5% by mass, based on the total mass of the plurality of crude-fiber crusted pellets present in the feed; and/or
at least 80% by volume of the plurality of crude-fiber crusted pellets present in the feed have a diameter of ≤20 mm, and/or
at least 80% by volume of the plurality of crude-fiber crusted pellets present in the feed have a diameter in the range from 2 to 20 mm, and/or
at least some of the plurality of crude-fiber crusted pellets are in a form of cylindrical strand fragments or strand cuts; and/or the one or more plant sources of crude fiber of the carrier pellets K1) of the plurality of crude-fiber crusted pellets present in the feed are present in a total amount of ≥30% by mass based on the total mass of the plurality of crude-fiber crusted pellets present in the feed; and/or the one or more plant sources of crude fiber of the carrier pellets K1) of the plurality of crude-fiber crusted pellets present in the feed are present in a total amount in the range from 47.5% to 97.5% by mass based on the total mass of the plurality of crude-fiber crusted pellets present in the feed.

10. A method for producing crude-fiber crusted pellets for use as animal feed, comprising steps of:
S1) producing or providing a plurality of carrier pellets K1) which comprise plant sources of crude fiber as defined in claim 1,
S2) producing or providing one or more feed additives K2b) as defined in either of claims 1 and 7,
S3) producing or providing one or more physiologically acceptable binders K2a) as defined in claim 1,
S4) applying the one or more binders K2a) produced or provided in step S3) and the one or more feed additives K2b) produced or provided in step S2) to the plurality of carrier pellets produced or provided in step S1).

11. The method as claimed in claim 10, wherein in step S4)
the one or more binders K2a) and the one or more feed additives K2b) are applied simultaneously to the plurality of carrier pellets; or
the one or more binders K2a) and the one or more feed additives K2b) are applied to the plurality of carrier pellets once, twice or more than twice.

12. The method as claimed in claim 10, wherein
in step S4) the plurality of carrier pellets K1) is set in rotation and the one or more binders K2a) and the one or more feed additives K2b) are applied to the carrier pellets of the plurality of carrier pellets set in rotation, once, twice or more than twice; and/or
in step S4) at least some of the produced or provided plurality of carrier pellets K1) is set in rotation by swirling in a gas atmosphere and application of the one or more binders K2a) produced or provided in step S3) and/or of the one or more feed additives K2b) produced or provided in step S2) is done to the carrier pellets K1) thus set in rotation; and/or
in step S2) the one or more feed additives K2b) are produced or provided in powder form, gel form and/or liquid form.

13. A plurality of crude-fiber crusted pellets for use as animal feed, produced or producible by a method as claimed in claim 10.

14. The use of a pellet comprising one or more plant sources of crude fiber in a total amount of ≥85% by mass, based on the total mass of the pellet, or consisting of plant sources of crude fiber, as a carrier pellet for the production of a crude-fiber crusted pellet,
wherein the crude-fiber crusted pellet has a crust which partially or completely covers the surface of the carrier pellet and which comprises one or more physiologically acceptable binders and one or more feed additives.

15. The use of one or more feed additives, as defined in claim 1, for coating carrier pellets which comprise plant sources of crude fiber, for coating a plurality of carrier pellets K1) as defined in claim 1.

16. The crude-fiber crusted pellet as claimed in claim 2, wherein the carrier pellet K1)
comprises the one or more plant sources of crude fiber in a total amount in a range from ≥85% by mass to ≤100% by mass, or
consists of one or more plant sources of crude fiber.

17. The crude-fiber crusted pellet as claimed in claim 3, wherein the plant material comprises alfalfa or alfalfa meal.

18. The crude-fiber crusted pellet as claimed in claim 5, wherein:
one, two or more than two further bilayers BM)/FA) are arranged on the layer FA) of the first bilayer BM)/FA), such that the carrier pellet K1) is partially or completely covered by a plurality of alternating bilayers BM)/FA) that forms the crust K2), or
there is alternation in the crust K2) between a layer BM) comprising one or more physiological binders K2a) and a layer FA) comprising one or more feed additives K2b), such that each layer BM) fixes a layer FA) arranged on said layer BM) on the next layer arranged under said layer BM).

19. The crude-fiber crusted pellet as claimed in claim 6, wherein,
wherein the plant cell-wall material comprises a plant cell-wall material which stems from whole plants, plant parts and/or processed plant products of one or more plant species in each case; and/or
the one or more plant sources of crude fiber of the carrier pellet K1) comprise cellulose-containing plant material; and/or
the one or more plant sources of crude fiber of the carrier pellet K1) comprise fibrous plant material; and/or
the one physiologically acceptable binder K2a) or least one, several or all of the one or more physiologically acceptable binders K2a) are selected from the group consisting of carboxymethylcelluloses, dextrins, alginates, starch, xanthan gum, molasses and vinasse.

20. The method as claimed in claim 10, wherein the crude-fiber crusted pellets are produced such that crude-fiber crusted pellets result, wherein the surface of the plurality of carrier pellets is partially or completely covered in each case by a crust comprising or consisting of one or more physiologically acceptable binders and one or more feed additives.
